(19) United States
(12) Patent Application Publication
(10) Pub. No.: US 2004/0099510 A1
(43) Pub. Date: May 27, 2004

(54) Apparatus for controlling a belt used in the continously operated thermal treatment of a material bed

(76) Inventors: Martti Jankkila, Tornio (FI); Eero Vaananen, Tornio (FI)

Correspondence Address: SMITH-HILL AND BEDELL, 12670 N W BARNES ROAD, SUITE 104, PORTLAND, OR, 97229

(21) Appl. No.: 10/344,623

(22) PCT Filed: Jul. 19, 2001
(86) PCT No.: PCT/FI01/00676

(30) Foreign Application Priority Data
Jul. 19, 2000 (FI) 20001683

(51) Int. Cl. B65G 39/16

(52) U.S. Cl. 198/806

(57) ABSTRACT

The invention relates to an apparatus for controlling a conveyor belt used in the continuously operated thermal treatment of a material bed, i.e. in continuously operated sintering, where the conveyor belt can be made to operate between a transmission drum and a bending drum. According to the invention, in order to control the conveyor belt (4, 23), at least on the portion proceeding from the transmission drum (2) to the bending drum (3, 22), to the conveyor arrangement there is connected at least one alignment element (9, 25), which is further connected to at least one roller (11, 27) guiding the conveyor belt (4, 23) in order to move the roller (11, 27) at least in the direction of the plane defined by the conveyor belt (4, 23).

The present invention relates to an apparatus that controls a belt used in the continuously operated thermal treatment of a material bed, i.e. continuously operated sintering, advantageously between the transmission drum and the bending drum.

Nowadays in continuously operated sintering, there is generally used a conveyor-type sintering device, where on the conveyor belt, there is first formed a material bed. Generally the material bed consists of essentially spherical, fragile pellets, which are hardened by means of sintering, so that the pellets can be fed to further treatment for instance in a smelting furnace. In the sintering of the material bed, through the material bed placed on the conveyor belt, and simultaneously through the conveyor belt itself, there is first conducted hot gas, so that the temperature of the material bed is raised, for example in the case of ferro-alloy pellets, up to the temperature range of 1300-1600° C. At a high temperature, the fragile pellets react with the hot gas and are thereby hardened. Thereafter the hardened pellets constituting the material bed are cooled by conducting cooling gas through the material bed and the conveyor belt. Consequently, a conveyor belt used in continuously operated sintering operations under remarkable changes of temperature, which causes thermal expansion in the conveyor belt and respectively thermal contraction, as well as resulting tensile stress, and makes it difficult to control the conveyor belt.

In a continuously operated, conveyor-type thermal treatment of a material bed, it is advantageous that the conveyor belt that returns from the bending drum to the thermal treatment area is positioned essentially in the desired conveying direction, because in that case the hot gases used in the thermal treatment can advantageously be conducted through the conveyor belt via the perforated lines made in the conveyor belt. The controlling of a conveyor belt used in continuously operated sintering is generally carried out by means of cylinders connected to the bending drum of the conveyor belt, which cylinders turn the bending drum in order to prevent the slipping of the conveyor belt. However, the turning of the bending drum by means of cylinders causes essentially high stresses to the conveyor belt with respect to tensile stress. Owing to the effect of the described tensile stresses, the conveyor belt is stretched to an unnecessary degree. The stretching is worst in cases where the temperature of the conveyor belt is high and varies on both sides of the conveyor belt. In that case also the middle part of the conveyor belt can be overheated and cause slipping of the belt.

For controlling a conveyor belt used in continuously operated sintering, there also are used rollers that guide the edge of the conveyor belt. However, said edge-guiding rollers cause deformations in the edges of the essentially hot conveyor belt, which as such shortens the working life of the belt.

The object of the present invention is to eliminate some of the drawbacks of the prior art and to achieve an improved apparatus for controlling a conveyor belt used in the continuously operated thermal treatment of a material bed, in continuously operated sintering, which apparatus controls the conveyor belt at least at one spot, and at least between the transmission drum and the bending drum of the conveyor belt, advantageously in the vicinity of the bending drum. The essential novel features of the invention are apparent from the appended claims.

According to the invention, for the controlling of a conveyor belt used in the continuously operated thermal treatment of a material bed, in continuously operated sintering, in connection with the conveyor arrangement, there is installed at least one alignment element, which on the basis of the information obtained from an element measuring the position of the conveyor belt changes the position of at least one roller guiding the position of the conveyor belt, at least on the horizontal level with respect to the proceeding direction of the conveyor belt. Advantageously the alignment element is placed near the bending drum of the conveyor belt. The alignment element can also be connected to the bending drum itself, in which case the alignment element changes the position of the bending drum with respect to the proceeding direction of the conveyor belt.

The alignment element according to the invention for controlling a conveyor belt is advantageously installed movably in the frame structure of the conveyor arrangement, so that the operation of the alignment element is carried out pneumatically, hydraulically or electronically. The alignment element as such controls at least one roller that guides the conveyor belt returning from the transmission drum of the conveyor arrangement to the bending drum, the position of which roller with respect to the conveyor belt can advantageously be adjusted. In the continuously operated thermal treatment of a material bed, in continuously operated sintering, the conveyor arrangement of the conveyor belt is advantageously installed so that the conveyor belt moves in an essentially horizontal direction both when proceeding through the various process steps and when returning from said process steps. The roller guiding the conveyor belt is moved by means of an alignment element according to the invention in an essentially horizontal direction determined by the trajectory of the conveyor belt, but advantageously also in a direction that is essentially vertical with respect to the trajectory of the conveyor belt.

The position of the alignment element according to the invention with respect to the bending drum and the transmission drum of the conveyor arrangement is advantageously such that the distance of the alignment element from the bending drum is within the range 0-50%, advantageously 10-30%, when calculated from the distance between the rotary axles of the transmission drum and the bending drum. When employing, according to the invention, at least two alignment elements for guiding the rollers of the conveyor belt, one alignment element can, when desired, be installed directly in connection with the bending drum, in which case also the bending drum participates in the controlling of the conveyor belt.

For an advantageous operation of the alignment element according to the invention, said alignment element is connected to an arrangement measuring the proceeding direction of the conveyor belt, after the bending drum, but before the conveyor belt proceeds to the process stage. On the basis of the result obtained from the arrangement measuring the proceeding direction, the alignment element adjusts the position of the roller guiding the conveyor belt, so that the desired proceeding direction of the conveyor belt can be maintained. In order to adjust the position of the roller guiding the conveyor belt by means of the alignment element, the roller is provided with at least one roller moving element. When using advantageously only one roller moving element, which is preferably installed near to one end of the roller, when changing the roller position the opposite end of the roller remains essentially in place. In that case the roller position can advantageously be adjusted, so that the roller forms, in the direction of the plane defined by the conveyor belt, an angle within the range of 0-15 degrees with the non-controllable rollers that constitute the trajectory of the conveyor belt. The moving element can also be installed so that when moving the position of the roller, the position of essentially the whole roller is changed with respect to the conveyor belt. Further, the moving element can also be installed so that the moving element is simultaneously connected to several rollers guiding the conveyor belt, in which case by one and the same moving element, there can simultaneously be moved at least two rollers guiding the conveyor belt.

In order to make the adjusting of the position of the roller, realized by means of the alignment element according to the invention, for guiding the conveyor belt more effective, the conveyor arrangement is provided with a guiding element whereby the roller guiding the conveyor belt can also be moved in the vertical direction in order to lift the conveyor belt essentially higher from the direction defined by the plane parallel to the conveyor belt. The angle of elevation achieved by means of the guiding element for the roller guiding the conveyor belt is no more than 5 degrees.

The invention is explained in more detail with reference to the appended drawings, where

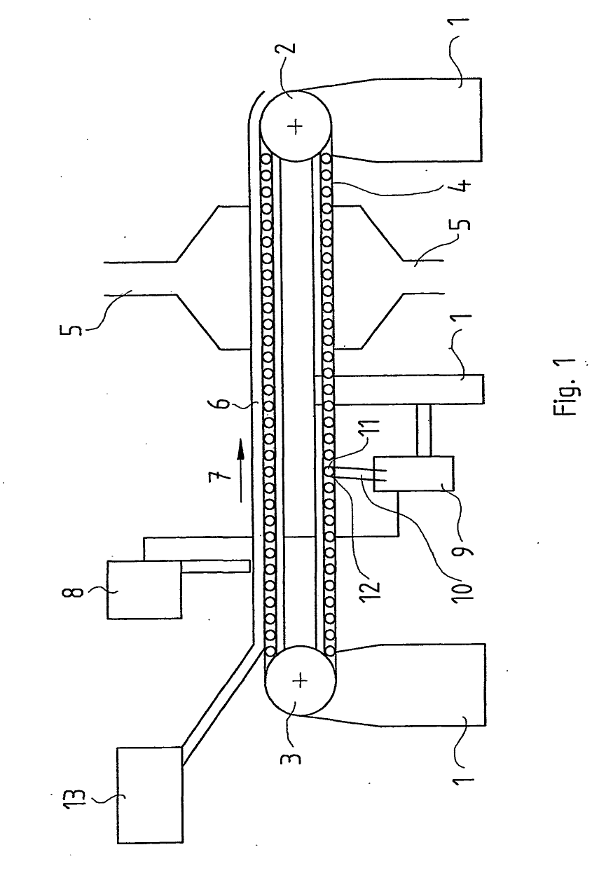

FIG. 1 is a schematical illustration of a preferred embodiment of the invention, seen from the side, and

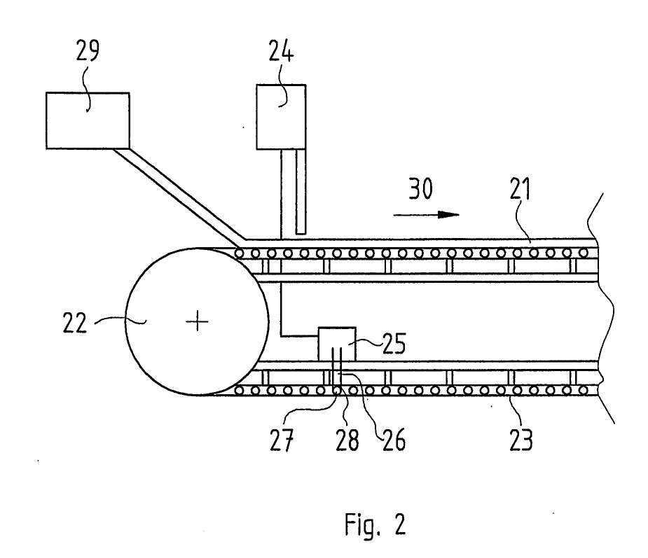

FIG. 2 is a schematical illustration of another preferred embodiment of the invention, seen from the side.

According to FIG. 1, in the frame structure 1 of the conveyor arrangement used for the thermal treatment of the material bed 6 fed from the feeding arrangement 13, i.e. to sintering, there is installed a transmission drum 2 and a bending drum 3. Between the transmission drum 2 and the bending drum 3, there is installed a conveyor belt 4. The conveyor belt 4 is made to proceed through a continuously operated sintering arrangement 5, where the material bed 6 placed on the conveyor belt is sintered in a way known as such. In order to measure the position of the part of the conveyor belt 4 returning from the bending drum 3 to the transmission drum 2, above the conveyor belt 4, in the proceeding direction 7 thereof, after the bending drum 3 there is installed a measuring arrangement 8. In order to guide the conveyor belt 4 before the bending drum 3, the frame structure 1 is provided with an alignment element 9, which is by intermediation of the moving element 10 connected to a roller 11 guiding the belt. The alignment element 9 is connected to the measuring arrangement 7 of the conveyor belt direction.

When the conveyor belt 4 connected to the conveyor arrangement is used in connection with the sintering of the material bed, the measuring arrangement 8 is used for continuously measuring the position of the conveyor belt 4 with respect to the desired position of the conveyor belt and to the proceeding direction 7 thereof. On the basis of the information obtained of the position of the conveyor belt 7, the alignment element 9 adjusts, when necessary, the roller 11 guiding the conveyor belt by means of a moving element 10. In connection with the guiding roller 11, there also is installed a guiding element 12, by means of which there can be achieved a vertical component in the moving of the guiding roller 11.

In the embodiment according to FIG. 2, in the vicinity of the bending drum 22 of the conveyor arrangement used for the thermal treatment, i.e. sintering, of a material bed 21 fed from the feeding arrangement 29, in the proceeding direction 30 of the conveyor belt 23, there is installed, after the bending drum 22, a measuring arrangement 24 for measuring the position of the conveyor belt 23. The measuring arrangement 24 is connected to the alignment element 25 of the conveyor belt 23, which element is installed in the proceeding direction of the conveyor belt 23, prior to the bending drum 22. To the alignment element 25, there is connected a moving element 26, whereby the roller 27 guiding the conveyor belt 23 can be moved in order to advantageously align the roller 27. In connection with the guiding roller 27, there also is installed a guiding element 28, whereby there can be achieved a vertical component in the moving of the guiding roller 27.

1. An apparatus for controlling a conveyor belt used in a continuously operated thermal treatment of a material bed, i.e. in continuously operated sintering, where the conveyor belt can be made to operate between a transmission drum and a bending drum, characterized in that in order to control the conveyor belt (4, 23), at least on the portion proceeding from the transmission drum (2) to the bending drum (3, 22), to the conveyor arrangement there is connected at least one alignment element (9, 25), which is further connected to at least one roller (11, 27) guiding the conveyor belt (4, 23) in order to move the roller (11, 27) at least in the direction of the plane defined by the conveyor belt (4, 23).

2. An apparatus according to claim 1, characterized in that the distance of the alignment element (9, 25) from the bending drum is within the range 0-50%, advantageously 10-30%, when calculated from the distance between the rotary axles of the transmission drum (2) and bending drum (3, 22) of the conveyor arrangement.

3. An apparatus according to claim 1 or 2, characterized in that in connection with the roller (11, 27) controlled by the alignment element (9, 25), there also is installed a guiding element (12, 28), whereby a vertical component can be achieved in the motion of the guiding roller (11, 27).

4. An apparatus according to any of the preceding claims, characterized in that the moving element (10, 26) of the roller (11, 27) to be controlled by the alignment element (9, 25) is installed, with respect to the roller (11, 27), near one end of the roller (11, 27), so that when adjusting the roller position, the opposite end of the roller (11, 27) remains essentially in place.

5. An apparatus according to claim 4, characterized in that the roller (11) forms, in the direction defined by the level formed by the conveyor belt (4, 23), an angle within the range 0-15 degrees with non-controllable rollers constituting the roller trajectory of the conveyor path.

6. An apparatus according to claim 1, 2 or 3, characterized in that at least one moving element (10, 26) of the roller (11, 27) to be controlled by the alignment element (9, 25) is installed with respect to the roller (11, 27), so that when adjusting the position of the roller (11, 27), essentially the position of the whole roller (11, 27) with respect to the conveyor belt (4, 23) is changed.

7. An apparatus according to any of the preceding claims, characterized in that in connection with the roller (11, 27) controlled by the alignment element (9, 25), there is installed a guiding element (12, 28) for lifting the guiding roller (11, 27).

8. An apparatus according to claim 7, characterized in that the angle created on the roller (11, 27) controlled by the guiding element (12) is within the range 0-5 degrees.

9. An apparatus according to claim 1, characterized in that the alignment element (9, 25) is connected to the bending drum (3, 22), which serves as the roller guiding the conveyor belt (4, 23).
